(19) United States
(12) Patent Application Publication
(10) Pub. No.: US 2013/0119626 A1
(43) Pub. Date: May 16, 2013

(54) ATTACHMENT STRUCTURE AND STROLLER THEREWITH

(71) Applicant: Robert E. Haut, West Chester, PA (US)

(72) Inventor: Robert E. Haut, West Chester, PA (US)

(21) Appl. No.: 13/439,854

(22) Filed: Apr. 5, 2012

(30) Foreign Application Priority Data
Nov. 16, 2011 (CN) 201120453846.2

(51) Int. Cl. B62B 7/00; F16C 11/04

(52) U.S. Cl. 280/47.38; 403/150

(57) ABSTRACT

An attachment structure and a stroller therewith are disclosed. The stroller includes a stroller frame, a tray, and the attachment structure. The attachment structure is used for attaching the tray to the stroller frame includes a first engaging structure and a second engaging structure disposed on the tray and the stroller frame oppositely. The first engaging structure has a first hole; the second engaging structure has a pivot post and a flexible retaining portion formed on the pivot post. The pivot post passes through the first hole. The flexible retaining portion is capable of hooking the first hole for preventing the pivot post from being disengaged from the first hole. Thereby, the operation of attaching the tray to the stroller frame can be simple and time-saved, and the attachment structure still can be strong enough even without additional hardware and steel members.

### BACKGROUND OF THE INVENTION

1. Field of the Invention

The invention relates to an attachment structure and a stroller, and especially relates to an attachment structure for attaching a tray to a stroller and relates to a stroller therewith.

2. Description of the Prior Art

Strollers commonly have a tray located in the front of the seating area for the convenience of the child. Tray can hold snacks, drinks, and toys for child and also act as a passive restraint keeping the child in his seat so he does not fall out of the front of the stroller. Most often, the tray can pivot out of the way of the child to allow egress. In order for the tray to restrain the child safely, a secure attachment of the tray to the stroller is paramount otherwise if the child leans against the tray, it might give way causing the child to fall out.

The tray is typically attached to the stroller at two points on either side of the tray: one can act as a pivot, and the other as a latch. The latch side is normally a movable latch or hook and the pivot a round post. In order to ensure reliability of the secure attachment of the tray to the stroller, additional hardware and fasteners are used such as metal spring buttons, metal washers, and/or screws to attach the plastic tray to the plastic stroller mount retaining the tray on the pivot post. For strength, the pivot post may be constructed from steel. The need for additional hardware and steel members is costly because of the added parts and time required for assembling the parts during manufacturing. There is also a risk that the multiple parts may be misassembled or forgotten rendering the stroller unsafe.

### SUMMARY OF THE INVENTION

An objective of the invention is to provide an attachment structure for attaching a tray to a frame. The attachment structure uses a flexible part formed on a pivot post to simplify the structure and assembly thereof without strength reduction.

The attachment structure includes a first engaging structure and a second engaging structure. The first engaging structure has a first hole. The second engaging structure has a pivot post and a flexible retaining portion formed on the pivot post. The first engaging structure and the second engaging structure are disposed on the tray and the frame oppositely. The pivot post passes through the first hole. The flexible retaining portion is capable of hooking the first hole for preventing the pivot post from being disengaged from the first hole. Thereby, the operation of attaching the tray to the frame can be simple and time-saved, and the attachment structure still can be strong enough even without additional hardware and steel members.

Another objective of the invention is to provide a stroller with the attachment structure of the invention. The stroller includes a stroller frame, a tray, and an attachment structure. The attachment structure is used for attaching the tray to the stroller frame and includes a first engaging structure and a second engaging structure. The first engaging structure has a first hole. The second engaging structure has a pivot post and a flexible retaining portion formed on the pivot post . The first engaging structure and the second engaging structure are disposed on the tray and the stroller frame oppositely. The pivot post passes through the first hole. The flexible retaining portion is capable of hooking the first hole for preventing the pivot post from being disengaged from the first hole. Similarly, the operation of attaching the tray to the stroller frame can be simple and time-saved, and the attachment structure still can be strong enough even without additional hardware and steel members.

In sum, compared to the prior art, the invention simplify the structure of the pivotal connection between the tray and the stroller frame without strength reduction by forming the flexible retaining portion directly on the pivot post, which is time-saved and reliable to the assembly of the attachment structure itself and also to the attaching operation thereof. Therefore, the invention can achieve a reliable structure by using fewer components and avoid the risk in the prior art that the multiple parts may be misassembled or forgotten rendering the stroller unsafe. Furthermore, in general, the attachment structure with fewer components also shows time-saved, low-priced, and reliable manufacturing.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a side view of a stroller of a preferred embodiment according to the present invention.

FIG. 2 is an enlarged view of an attachment structure and a part of a tray of the stroller in FIG. 1.

FIG. 3 is an exploded view of the attachment structure in FIG. 2.

FIG. 4 is a sectioned view of a pivot post and a first flexible retaining portion of the attachment structure in FIG. 2 when passing through a first hole of the attachment structure.

FIG. 5 is a side view of the attachment structure and a part of the tray in FIG. 2.

### DETAILED DESCRIPTION

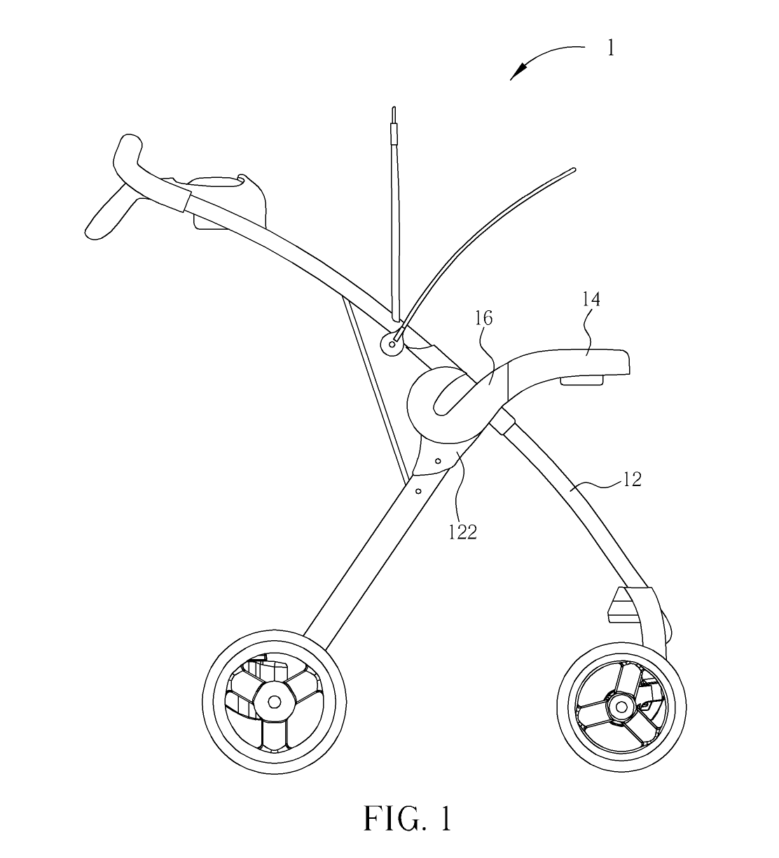

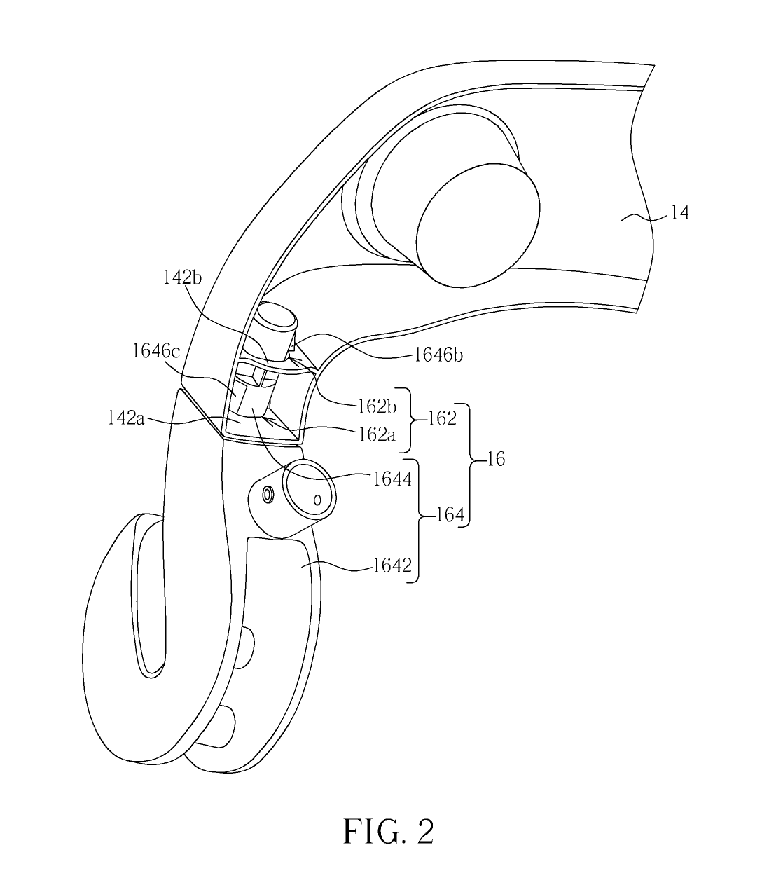

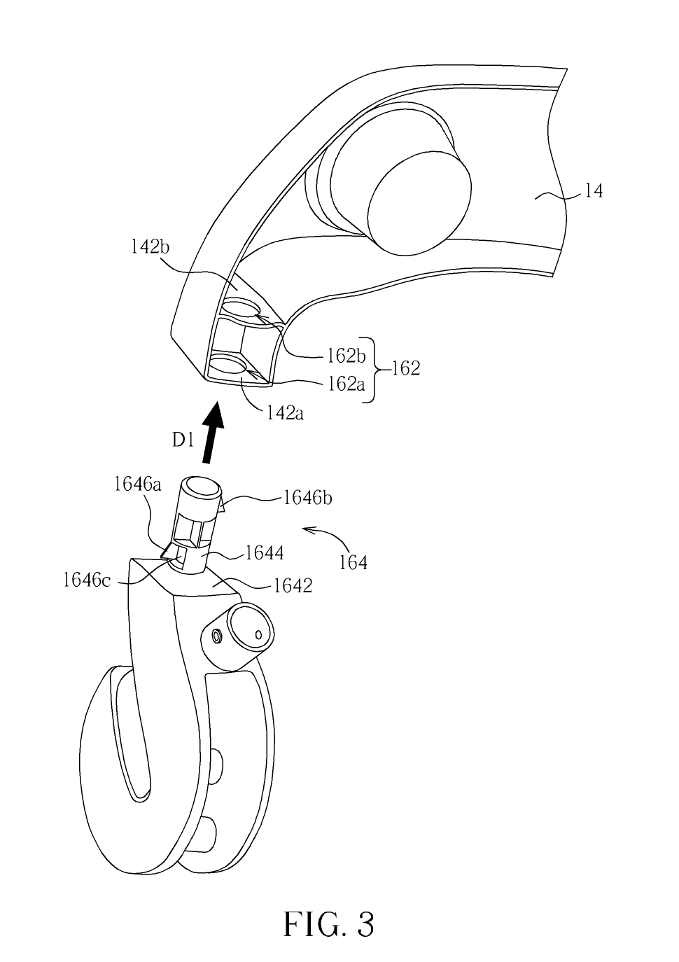

Please refer to FIG. 1, which is a side view of a stroller 1 of a preferred embodiment according to the present invention. The stroller 1 includes a stroller frame 12, a tray 14, and an attachment structure 16 for attaching the tray 14 to the stroller frame 12. Please also refer to FIG. 2 and FIG. 3. FIG. 2 is an enlarged view of the attachment structure 16 and a part of the tray 14 in another view point different to that for FIG. 1. FIG. 3 is an exploded view of the attachment structure 16 in FIG. 2. The attachment structure 16 includes a first engaging structure 162 and a second engaging structure 164. The first engaging structure 162 is disposed on the tray 14. The second engaging structure 164 is disposed on the stroller frame 12 correspondingly. The tray 14 is attached to the stroller frame 12 by engaging the first engaging structure 162 with the second engaging structure 164.

The first engaging structure 162 includes a first hole 162a and a second hole 162b, disposed on the tray 14 in an engagement direction D1. In the embodiment, the first hole 162a and the second hole 162b are directly formed on structural members 142a and 142b respectively of the tray 14; that is, the first engaging structure 162 and the tray 14 are formed in one piece. In practice, the first hole 162a and the second hole 162b can be molded into the plastic injection molded tray 14, which reduces manufacturing time and improves the strength and reliability of the bonding of the first engaging structure 162 with the tray 14. However, the invention is not limited thereto. For example, the first hole 162a and the second hole 162b can be formed by drilling the tray 14 after injection. In addition, in the embodiment, the structural members 142a and 142b are ribs of the tray 14, but the invention is not limited thereto.

The second engaging structure 164 includes amount 1642, a pivot post 1644, a first flexible retaining portion 1646a, and a second flexible retaining portion 1646b. The mount 1642 is integrated into a pivotal mechanism 122 for supports of the stroller frame 12; however, the invention is not limited thereto. The pivot post 1644 is fixedly disposed on the mount 1642. The first flexible retaining portion 1646a and the second flexible retaining portion 1646b are disposed substantially in the engagement direction D1 on the surface of the pivot post 1644. In the embodiment, the second engaging structure 164 is formed in one piece such as by plastic injection. The first flexible retaining portion 1646a and the second flexible retaining portion 1646b extend in radial directions of the pivot post 1644, i.e. perpendicular to the engagement direction D1. Furthermore, the first flexible retaining portion 1646a and the second flexible retaining portion 1646b extend incrementally in a direction reverse to the engagement direction D1, for easily passing through the first hole 162a and the second hole 162b and for preventing the pivot post 1644 from being disengaged from the first hole 162a and the second hole 162b after the first engaging structure 162 and the second engaging structure 164 are engaged. In the embodiment, the first flexible retaining portion 1646a and the second flexible retaining portion 1646b are triangle-shaped; however, the invention is not limited thereto.

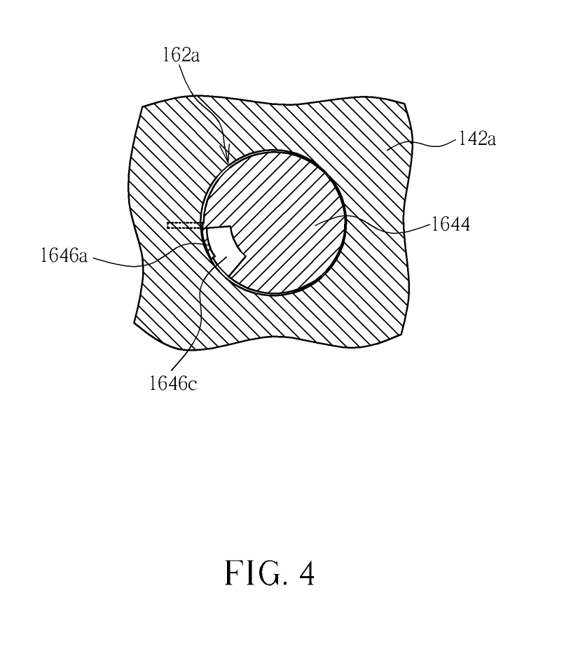

Please refer to FIGS. 2 through 4. FIG. 4 is a sectioned view of the pivot post 1644 and the first flexible retaining portion 1646a when passing through the first hole 162a. In an actual attachment of the tray 14 to the stroller frame 12, the pivot post 1644 is inserted into the first hole 162a and the second hole 162b. The second flexible retaining portion 1646b, formed at the distal portion of the pivot post 1644, passes through the first hole 162a and the second hole 162b, while the first flexible retaining portion 1646a, formed at the root portion of the pivot post 1644, passes through only the first hole 162a. The first flexible retaining portion 1646a and the second flexible retaining portion 1646b are capable of being flexed for passing through the first hole 162a and the second hole 162b.

In the embodiment, the second engaging structure 164 has a relief recess 1646c formed on the pivot post 1644 and adjacent to the first flexible retaining portion 1646a, so when the pivot post 1644 and the first flexible retaining portion 1646a is passing through the first hole 162a, the first flexible retaining portion 1646a can be flexed into the relief recess 1646c so that the size of the first hole 162a can be just a little bit larger than that of the pivot post 1644 together with the first flexible retaining portion 1646a. It is conducive to pivotal stability of the tray 14 relative to the stroller frame 12. However, the invention is not limited thereto. After passed the first hole 162a, the first flexible retaining portion 1646a springs back to its original position, as shown by dashed lines in FIG. 4. The above description is also applicable to the second flexible retaining portion 1646b and is not repeated herein.

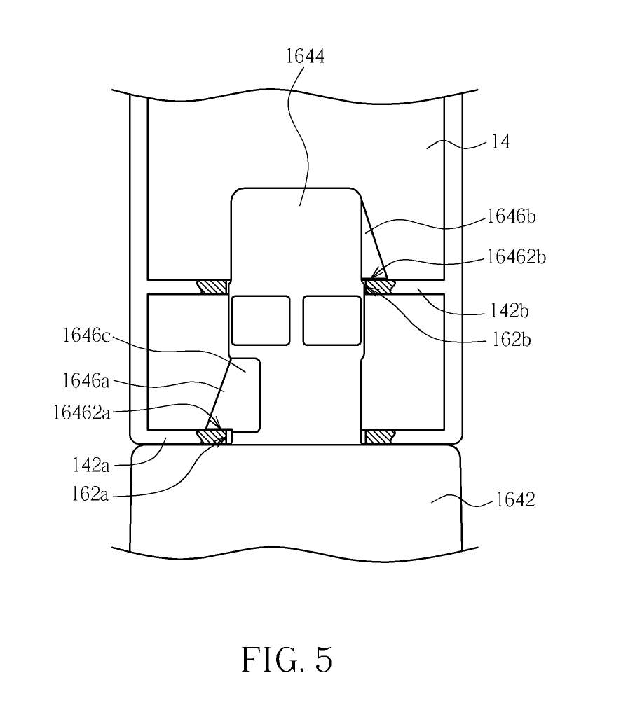

Please refer to FIG. 2 and FIG. 5. FIG. 5 is a side view of the attachment structure 16 and a part of the tray 14; therein, the structural members 142a and 142b are partially sectioned. The first flexible retaining portion 1646a and the second flexible retaining portion 1646b spring back after passing through the first hole 162a and the second hole 162b respectively, so that the first flexible retaining portion 1646a and the second flexible retaining portion 1646b can hook the first hole 162a and the second hole 162b by their bottom edges 16462a and 16462b respectively for preventing the pivot post 1644 from being disengaged from the first hole 162a and the second hole 162b. Furthermore, in the embodiment, the first flexible retaining portion 1646a and the second flexible retaining portion 1646b are substantially oppositely disposed on the pivot post 1644, so that when the pivot post 1644 tends to disengage from the first hole 162a and the second hole 162b, the bottom edges 16462a and 16462b of the first flexible retaining portion 1646a and the second flexible retaining portion 1646b can provide symmetric retaining forces, which is conducive to structural stability thereof. However, the invention is not limited thereto.

It is added that in the above embodiment, the holes 162a and 162b correspond to the flexible retaining portions 1646a and 1646b respectively, but the invention is not limited thereto. In practice, the disposition quantity of the flexible retaining portion for each hole can be more than one, so that the retaining forces by the flexible retaining portion on each hole can be more symmetric and stable. In addition, in the above embodiment, the pivot post 1644 is constrained stably by passing through two holes 162a and 162b. In practice, the first engaging structure 162 and the second engaging structure 164 can be engaged by inserting the pivot post 1644 into only one hole, such as the first hole 162a. In such case, the engagement therefor still can be reliable by increasing the thickness of the structural members 142a so as to enhancing the constraint on the pivot post 1644 by the inner wall of the first hole 162a.

As discussed above, the attachment structure of the invention uses flexible part formed directly on the pivot post as retainer for hooking hole, so as to simplify the engaging structure therefor in comparison with the prior art. In general, the attachment structure with fewer components also shows time-saved, low-priced, and reliable manufacturing. It is time-saved and reliable to the assembly of the attachment structure itself and also to the attaching operation thereof. Therefore, the invention can achieve a reliable engagement structure and avoid the risk in the prior art that the multiple parts may be misassembled or forgotten rendering the stroller unsafe. In addition, the application of the attachment structure of the invention is not limited to stroller. Any carrier having a tray is also applicable, for example baby chair, rocking chair, baby walker and so on.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. An attachment structure for attaching a tray to a frame, the attachment structure comprising:
a first engaging structure having a first hole; and
a second engaging structure having a pivot post and a first flexible retaining portion formed on the pivot post, the first engaging structure and the second engaging structure being disposed on the tray and the frame oppositely, the pivot post passing through the first hole, the first flexible retaining portion being capable of hooking the first hole for preventing the pivot post from being disengaged from the first hole.

2. The attachment structure of claim 1, wherein the first flexible retaining portion extends in a radial direction of the pivot post.

3. The attachment structure of claim 2, wherein the pivot post is inserted into the first hole in an engagement direction, and the first flexible retaining portion extends incrementally in a direction reverse to the engagement direction.

4. The attachment structure of claim 1, wherein the first engaging structure has a second hole, the second engaging structure has a second flexible retaining portion formed on the pivot post, the pivot post also passing through the second hole, and the second flexible retaining portion is capable of hooking the second hole to prevent the pivot post from being disengaged from the second hole.

5. The attachment structure of claim 4, wherein the first flexible retaining portion and the second flexible retaining portion are substantially oppositely disposed on the pivot post.

6. The attachment structure of claim 1, wherein the second engaging structure has a relief recess adjacent to the first flexible retaining portion, and the first flexible retaining portion is capable of being flexed into the relief recess when the pivot post together with the first flexible retaining portion are passing through the first hole.

7. The attachment structure of claim 1, wherein the first engaging structure is disposed on the tray, the second engaging structure is disposed on the frame, and the first hole is directly formed on a structural member of the tray.

8. The attachment structure of claim 7, wherein the second engaging structure has a mount, the pivot post is fixedly disposed on the mount, and the mount is integrated into a structural member of the frame.

9. The attachment structure of claim 8, wherein the second engaging structure is formed in one piece.

10. A stroller, comprising:
a stroller frame;
a tray; and
an attachment structure for attaching the tray to the stroller frame, the attachment structure comprising:
a first engaging structure having a first hole; and
a second engaging structure having a pivot post and a first flexible retaining portion formed on the pivot post, the first engaging structure and the second engaging structure being disposed on the tray and the stroller frame oppositely, the pivot post passing through the first hole, the first flexible retaining portion being capable of hooking the first hole for preventing the pivot post from being disengaged from the first hole.

11. The stroller of claim 10, wherein the first flexible retaining portion extends in a radial direction of the pivot post.

12. The stroller of claim 11, wherein the pivot post is inserted into the first hole in an engagement direction, and the first flexible retaining portion extends incrementally in a direction reverse to the engagement direction.

13. The stroller of claim 10, wherein the first engaging structure has a second hole, the second engaging structure has a second flexible retaining portion formed on the pivot post, the pivot post also passing through the second hole, and the second flexible retaining portion is capable of hooking the second hole to prevent the pivot post from being disengaged from the second hole.

14. The stroller of claim 13, wherein the first flexible retaining portion and the second flexible retaining portion are substantially oppositely disposed on the pivot post.

15. The stroller of claim 10, wherein the second engaging structure has a relief recess adjacent to the first flexible retaining portion, and the first flexible retaining portion is capable of being flexed into the relief recess when the pivot post together with the first flexible retaining portion are passing through the first hole.

16. The stroller of claim 10, wherein the first engaging structure and the tray are formed in one piece, the second engaging structure is disposed on the stroller frame, and the first hole is directly formed on a rib of the tray.

17. The stroller of claim 16, wherein the second engaging structure has a mount, the pivot post is fixedly disposed on the mount, and the mount is integrated into a pivotal mechanism for supports of the stroller frame.

18. The stroller of claim 17, wherein the second engaging structure is formed in one piece.
